(19) United States
(12) Patent Application Publication
(10) Pub. No.: US 2002/0126491 A1
(43) Pub. Date: Sep. 12, 2002

(54) LED light bulb with threaded base

(76) Inventor: Chih-min Chen, Miaoli City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/800,723

(22) Filed: Mar. 8, 2001

(51) Int. Cl. F21V 3/00

(52) U.S. Cl. 362/363; 362/800; 362/374

(57) ABSTRACT

The present invention discloses a light emitted diode (LED) bulb, mainly comprising a bulb shell, a light bulb set, an isolating plug, and a supporting contact base for connecting directly to the alternating current (AC) for its application. It consumes low electricity and enhances the lifespan in a large extent, which can be applied for the general illumination in electric appliances and computer equipments, further extended to the use for signal lights, large display panel, third brake lights, and festival lights. Meanwhile, the present invention also improves the structure to enhance the convenience for its installation.

### BACKGROUND OF THE INVENTION

1. Field of the Invention

The present invention relates to a light emitted diode (LED) bulb, more particularly to a LED bulb that can be used with the alternating current (AC) that consumes low electric power and improves the lifespan of the LED bulb in a great extent.

2. Description of the Related Art

The conventional light bulb utilizes a tungsten filament for passing the electricity energy through it to generate the light energy. The two conductive posts supports and electrically couples to the tungsten filament for the light generation, and a glass bulb accommodates the tungsten filament and supports the electrical conduction. The glass bulb is filled with inert gas to extend the lifespan of the tungsten filament, and a plug member is used to seal the glass bulb to isolate and prevent the elements inside the glass bulb from the being contacted with the atmosphere. The two metallic conductive contact points are separately attached to the external periphery and the bottom end, and also connected to two conductive posts individually. The foregoing conventional bulb generally uses 110V or 220V alternating current (AC), and hence it has the shortcoming of having a high electricity consumption, generating more heat, shortening the lifespan, having a lower collision resistance and a slower response efficiency.

In the recent years, the value of the light emitted diode (LED) bulb products is recognized. Since the LED has the features of consuming less power, generating less heat, and having longer lifespan, higher collision resistance, and better response efficiency. It has been widely used for the general illumination in the fields of electric appliance and computer equipment. However, the conventional LED is mainly used with the direct current (DC), and if it has to be used with the alternating current (AC), it needs other peripherals to reduce the electric voltage, and modulate the electric power before it can be implemented for the use.

In summation of the above description about the prior art, that awaits for a breakthrough, and the present inventor bases on years of his experience in the related industry and conducts research and development to overcome the shortcomings of the conventional light bulb, and finally invents the LED bulb according to the present invention.

### SUMMARY OF THE INVENTION

The main objective of this invention is to provide a LED bulb that can be used with the alternating current (AC) that consumes low electric power and enhances the lifespan of the light bulb in a great extent. Furthermore, the application can be further extended to the use for signal lights, large display panel, third brake lights, and festival lights to improve its industrial value.

To make it easier for our examiner to understand the objective of the invention, its structure, innovative features, and its performance, we use a preferred embodiment together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 is a three-dimensional diagram illustrating the assembled structure of the present invention.

FIG. 2 is a three-dimensional diagram illustrating the disassembled parts of the present invention.

FIG. 3 illustrates the cross-section of the assembly according to the present invention.

FIG. 4 illustrates the circuit of the present invention.

### DETAILED DESCRIPTION OF THE PREFERRED EMBODIMENTS

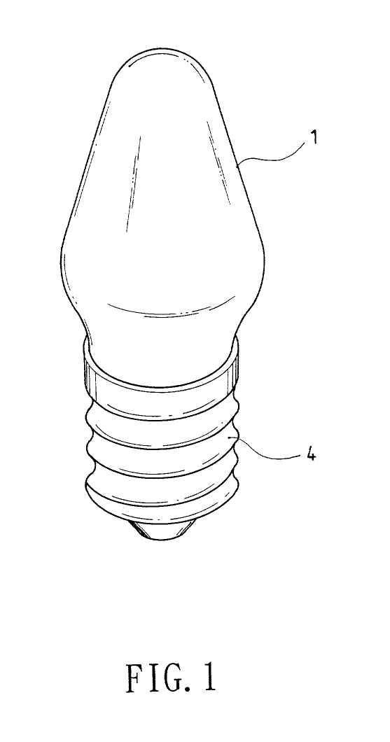

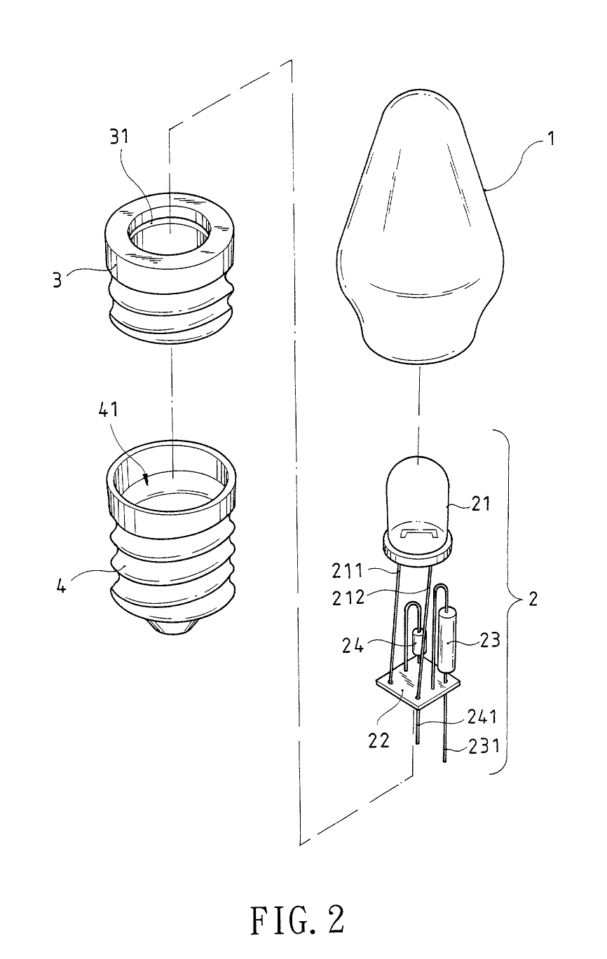

Please refer to FIGS. 1 and 2 for the LED bulb of the present invention. The LED bulb of the present invention comprises a bulb shell 1, a bulb set 2, an isolating plug 3, and a supporting contact base 4; wherein the bulb shell 1 is an integral hollow shell member, having a hollow-out circular hole at its bottom. The bulb set 2 comprises a LED 21, a circuit board 22, a resistor 23, and diode 24; wherein the bottom of the LED 21 has two supporting posts 211, 212, and the circuit board 22 has small holes for receiving and coupling the foregoing two supporting posts 211, 212 at the bottom of the LED 21. One end of the resistor 23 is a supporting leg in contact with the supporting leg 212 of the LED diode 21 and it continually couples to the circuit board 22. The other end of the resistor 23 is a supporting leg in contact with the supporting leg 231. The diode 24 has one of ends in contact with the supporting leg and the supporting post 211 of the LED 21 and continually couples to the circuit board 22. The other end of the diode 24 is the supporting contact leg 241.

The isolating plug 3 is an integral hollow plug member made of insulating material having screw threads along the periphery at the lower section for the fixing, and the isolating plug has a ringed flange at its upper section.

The supporting contact base 4 is an integral hollow supporting base made of electrically conductive material having a screw thread along its periphery for coupling to the assembly, and the interior of the supporting contact base 4 is an accommodating hollow 41.

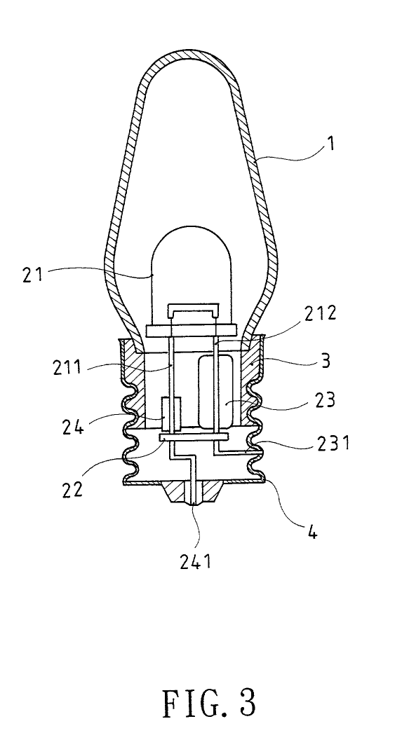

Please refer to FIGS. 2 and 3 again. The present invention by placing the light bulb set 2 in the accommodating hollow 41 of the supporting contact base 4, its supporting contact leg 241 is coupled to the bottom of the supporting contact base 4, and the other supporting contact leg 231 is in contact with the periphery at the middle section of the supporting contact base 4. The isolating plug 3 sleeves into the light bulb set 2 and the supporting contact base 4 are coupled with each other by screwing. The bulb shell 1 sleeves and covers the ringed flange 31 at the upper section of the isolating plug 3 to integrally couples the LED bulb.

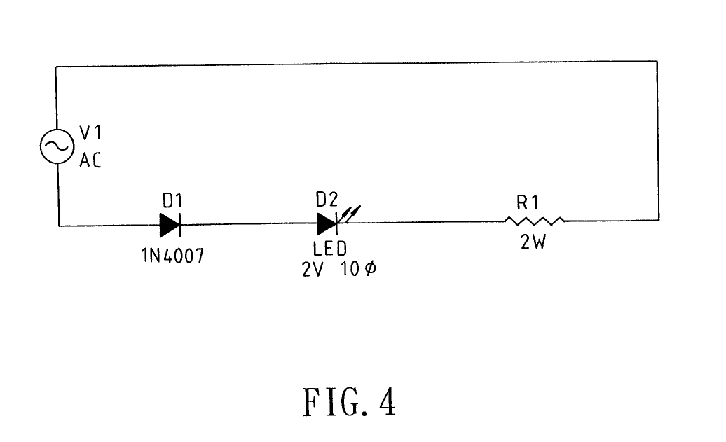

Refer to FIG. 4 for the circuit used in the structure of the present invention, it shows that the present invention attains the innovative function of being used with the alternating current, and the power consumption is about 2% of that used in the light bulb with tungsten filament. Additionally, the present invention generates less heat, consumes less electric power, possesses higher collision resistance and smaller volume, and it is applicable for different light emitted areas. The present invention improves the lifespan in a great extent, and breaks through the bottleneck of the technology in the illumination area giving additional industrial value to the conventional products.

In summation of the above description, the present invention herein overcomes the shortcomings of the conventional light bulbs, and LED used in the present invention can use the surface-mounted (SMD) LED devices or change the related components on the circuit board with integrated circuit for other embodiments of the present invention. It further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light emitted diode (LED) bulb, mainly comprising a bulb shell 1, a bulb set 2, an isolating plug 3, and a supporting contact base 4; wherein:
the bulb shell 1 being an integral hollow shell member, having a hollow-out circular hole at its bottom;
the bulb set 2 comprising a LED 21, a circuit board 22, a resistor 23, and diode 24; wherein the bottom of the LED 21 having two supporting posts 211, 212, and the circuit board 22 having a plurality of small holes for receiving and coupling the foregoing two supporting posts 211, 212 at the bottom of the LED 21, and one end of the resistor 23 being a supporting leg in contact with the supporting leg 212 of the LED diode 21and continually coupling to the circuit board 22, and the other end of the resistor 23 being a supporting leg in contact with the supporting leg 231;
and the diode 24 having one of ends in contact with the supporting leg and the supporting post 211 of the LED 21 and continually coupling to the circuit board 22, and the other end of the diode 24 being the supporting contact leg 241;
the isolating plug 3 being an integral hollow plug member made of insulating material having screw threads along the periphery at the lower section for the fixing, and the isolating plug having a ringed flange at its upper section;
the supporting contact base 4 being an integral hollow supporting base made of electrically conductive material having a screw thread along its periphery for coupling to the assembly, and the interior of the supporting contact base 4 being an accommodating hollow 41, thereby by placing the light bulb set 2 in the accommodating hollow 41 of the supporting contact base 4, the supporting contact leg 241 being coupled to the bottom of the supporting contact base 4, and the other supporting contact leg 231 being in contact with the periphery at the middle section of the supporting contact base 4; and the isolating plug 3 being sleeved into the light bulb set 2 and the supporting contact base 4 are coupled with each other by screwing, and the bulb shell 1 being sleeved and covered onto the ringed flange 31 at the upper section of the isolating plug 3 to integrally couple the LED bulb.
